(19) United States
(12) Patent Application Publication
(10) Pub. No.: US 2025/0166650 A1
(43) Pub. Date: May 22, 2025

(54) METHOD FOR REDUCING VOICE NOISE, METHOD FOR TRAINING MODEL, AND DEVICE

(71) Applicant: BIGO TECHNOLOGY PTE. LTD., Mapletree Business City (SG)

(72) Inventors: Shanyi WEI, Guangzhou (CN); Liang LIU, Guangzhou (CN)

(21) Appl. No.: 18/880,052

(22) PCT Filed: Jul. 12, 2023
(86) PCT No.: PCT/CN2023/106951

§ 371 Date: Dec. 30, 2024

(30) Foreign Application Priority Data
Jul. 21, 2022 (CN) 202210864010.4

(51) Int. Cl. G10L 21/0208; G10L 25/30; G10L 25/78

(52) U.S. Cl. CPC G10L 21/0208; G10L 25/30; G10L 25/78

(57) ABSTRACT

A method for reducing voice noise, including: acquiring an algorithm activity detection result corresponding to a current audio frame to be processed by detecting the current audio frame using a predetermined voice activity detection algorithm; acquiring a target activity detection result corresponding to the current audio frame by merging a model activity detection result corresponding to a previous audio frame and the algorithm activity detection result corresponding to the current audio frame, wherein the model activity detection result is outputted by a predetermined voice noise reduction network model; acquiring an initial noise reduction audio frame by performing, based on the target activity detection result, noise estimation and noise elimination on the current audio frame; and outputting a target noise reduction audio frame and a model activity detection result corresponding to the current audio frame by inputting the initial noise reduction audio frame into the predetermined voice noise reduction network model.

### CROSS REFERENCE OF RELATED APPLICATIONS

The present disclosure is based on and claims priority to Chinese Patent Application No. 202210864010.4, filed on Jul. 21, 2022, which is incorporated herein by reference in its entirety.

### TECHNICAL FIELD

The present application relates to the technical field of audio processing, and in particular, relates to a method and apparatus for reducing voice noise, a method and apparatus for training a model, and a device, a medium and a product thereof.

### BACKGROUND

With the rapid development of multimedia technologies, various conference, social contact and entertainment applications have emerged one after another, including voice calls, audio and video live broadcasts, and multi-person conferences, while voice quality is an important indicator to measure application performances.

A voice collected by a microphone of a terminal device usually has a certain degree of noises, and the noises carried in the voice can be suppressed using a voice noise reduction algorithm, thereby improving the intelligibility and voice quality of a voice.

At present, voice noise reduction solutions can be roughly categorized into two categories: traditional noise reduction solutions and artificial intelligence (AI) noise reduction solutions. The traditional noise reduction solutions are to achieve voice noise reduction in the form of signal processing, which cannot eliminate unsteady noises, that is, the noise reduction capability to burst noises is relatively weak. The AI noise reduction solutions have better noise reduction capability for both steady-state noises and unsteady noises. However, the AI noise reduction solutions are data-driven solutions and are very dependent on training samples. In the case that a scenario (e.g., in the case of low signal to noise ratio) that is not considered during model training is present, encountering this scenario in practice may lead to inestimable signal output and even system crash.

### SUMMARY

Embodiments of the present disclosure provide a method and apparatus for reducing voice noise, a method and apparatus for training a model, and a device, a medium and a product thereof, which can effectively combine a traditional noise reduction solution and an AI noise reduction solution, thereby improving a voice noise reduction effect.

According to an aspect of the present disclosure, a method for reducing voice noise is provided. The method includes: acquiring an algorithm activity detection result corresponding to a current audio frame to be processed by detecting the current audio frame using a predetermined voice activity detection algorithm; acquiring a target activity detection result corresponding to the current audio frame by merging a model activity detection result corresponding to a previous audio frame and the algorithm activity detection result corresponding to the current audio frame, wherein the model activity detection result is outputted by a predetermined voice noise reduction network model; acquiring an initial noise reduction audio frame by performing, based on the target activity detection result, noise estimation and noise elimination on the current audio frame; and outputting a target noise reduction audio frame and a model activity detection result corresponding to the current audio frame by inputting the initial noise reduction audio frame into the predetermined voice noise reduction network model.

According to another aspect of the present disclosure, a method for training a model is provided. The method includes: acquiring a sample algorithm activity detection result corresponding to a current sample audio frame by detecting the current sample audio frame using a predetermined voice activity detection algorithm, wherein the current sample audio frame is associated with an activity detection label and a pure audio frame; acquiring a target sample activity detection result corresponding to the current sample audio frame by merging a sample model activity detection result corresponding to a previous sample audio frame with a sample algorithm activity detection result corresponding to the current sample audio frame, wherein the sample model activity detection result is outputted by a voice noise reduction network model; acquiring an initial noise reduction sample audio frame by performing, based on the target activity sample detection result, noise estimation and noise elimination on the current sample audio frame; outputting a target sample noise reduction audio frame and a sample model activity detection result corresponding to the current sample audio frame by inputting the initial noise reduction sample audio frame into the voice noise reduction network model; and determining a first loss relationship based on the target sample noise reduction audio frame and the pure audio frame, determining a second loss relationship based on the sample model activity detection result and the activity detection label, and training the voice noise reduction network model based on the first loss relationship and the second loss relationship.

According to another aspect of the present disclosure, an apparatus for reducing voice noise is provided. The apparatus includes: a voice activity detecting module, a detection result merging module, a noise reduction processing module and a model inputting module.

The voice activity detecting module is configured to acquire an algorithm activity detection result corresponding to a current audio frame to be processed by detecting the current audio frame using a predetermined voice activity detection algorithm.

The detection result merging module is configured to acquire a target activity detection result corresponding to the current audio frame by merging a model activity detection result corresponding to a previous audio frame and the algorithm activity detection result corresponding to the current audio frame, wherein the model activity detection result is outputted by a predetermined voice noise reduction network model.

The noise reduction processing module is configured to acquire an initial noise reduction audio frame by performing, based on the target activity detection result, noise estimation and noise elimination on the current audio frame.

The model inputting module is configured to output a target noise reduction audio frame and a model activity detection result corresponding to the current audio frame by inputting the initial noise reduction audio frame into the predetermined voice noise reduction network model.

According to another aspect of the present disclosure, an apparatus for training a model is provided. The apparatus includes: a voice detecting module, a merging module, a noise eliminating module, a network model inputting module and a network model training module.

The voice detecting module is configured to acquire a sample algorithm activity detection result corresponding to a current sample audio frame by detecting the current sample audio frame using a predetermined voice activity detection algorithm, wherein the current sample audio frame is associated with an activity detection label and a pure audio frame.

The merging module is configured to acquire a target sample activity detection result corresponding to the current sample audio frame by merging a sample model activity detection result corresponding to a previous sample audio frame with a sample algorithm activity detection result corresponding to the current sample audio frame, wherein the sample model activity detection result is outputted by a voice noise reduction network model.

The noise eliminating module is configured to acquire an initial noise reduction sample audio frame by performing, based on the target activity sample detection result, noise estimation and noise elimination on the current sample audio frame.

The network model inputting module is configured to output a target sample noise reduction audio frame and a sample model activity detection result corresponding to the current sample audio frame by inputting the initial noise reduction sample audio frame into the voice noise reduction network model.

The network model training module is configured to determine a first loss relationship based on the target sample noise reduction audio frame and the pure audio frame, determine a second loss relationship based on the sample model activity detection result and the activity detection label, and train the voice noise reduction network model based on the first loss relationship and the second loss relationship.

According to another aspect of the present disclosure, an electrical device is provided. The electrical device includes: at least one processor; and a memory being in communication connection with the at least one processor, wherein the memory is configured to store a computer program executable by the at least one processor, the computer program, when executed by the at least one processor, causes the at least one processor to perform the method for reducing voice noise and/or the method for training a model provided by any embodiment of the present disclosure.

According to another aspect of the present disclosure, a computer-readable storage medium is provided. The computer-readable storage medium is configured to store a computer program therein, the computer program, when run by a processor, causes the processor to perform the method for reducing voice noise and/or the method for training a model provided by any embodiment of the present disclosure.

According to another aspect of the present disclosure, a computer program product is provided. The computer program product includes a computer program, the computer program, when run by a processor, causes the processor to perform the method for reducing voice noise and/or the method for training a model provided by any embodiment of the present disclosure.

According to the solution for reducing voice noise provided by the embodiments of the present disclosure, the algorithm activity detection result corresponding to the current audio frame to be processed is acquired by detecting the current audio frame using the predetermined voice activity detection algorithm; the target activity detection result corresponding to the current audio frame is acquired by merging the model activity detection result corresponding to the previous audio frame and the algorithm activity detection result corresponding to the current audio frame, wherein the model activity detection result is outputted by the predetermined voice noise reduction network model; the initial noise reduction audio frame is acquired by performing, based on the target activity detection result, noise estimation and noise elimination on the current audio frame; and the target noise reduction audio frame and the model activity detection result corresponding to the current audio frame are output by inputting the initial noise reduction audio frame into the predetermined voice noise reduction network model. By adopting the above solution, the predetermined voice noise reduction network model can output the model activity detection result, and in the case that the current audio frame is processed by the traditional voice noise reduction algorithm, the model activity detection result of the previous audio frame can be merged with the algorithm activity detection result acquired by the traditional voice noise reduction algorithm, such that the traditional noise reduction algorithm can acquire more activity detection information and determine the voice activity detection result more reasonably and accurately. Based on this result, noise estimation and noise elimination can be performed to protect voices and eliminate more noises well, thereby acquiring the traditional noise reduction results with higher signal to noise ratio. Then, the traditional noise reduction results are used as an input of the predetermined voice noise reduction network model, and the noise reduction audio frame with better effect is acquired, thereby reducing the possibility of bad data processed by the predetermined voice noise reduction network model. The traditional noise reduction algorithm and the AI noise reduction method promote each other, and have good noise reduction capability for various noises, thereby promoting a voice noise reduction effect and improving the stability and robustness of the overall voice noise reduction solution.

### BRIEF DESCRIPTION OF DRAWINGS

The following introduces the accompanying drawings required for describing the embodiments, the accompanying drawings in the following description show merely some embodiments of the present disclosure, and a person of ordinary skill in the art may still derive other drawings from these accompanying drawings without creative efforts.

FIG. 1 is a schematic flowchart of a method for reducing voice noise according to some embodiments of the present disclosure;

FIG. 2 is a schematic flowchart of another method for reducing voice noise according to some embodiments of the present disclosure;

FIG. 3 is a schematic flowchart of reasoning of a method for reducing voice noise according to some embodiments of the present disclosure;

FIG. 4 is a schematic flowchart of a method for training a model according to some embodiments of the present disclosure;

FIG. 5 is a schematic diagram of a training process of a method for training a model according to some embodiments of the present disclosure;

FIG. 6 is a schematic block diagram of an apparatus for reducing voice noise according to some embodiments of the present disclosure;

FIG. 7 is a structural block diagram of an apparatus for training a model according to some embodiments of the present disclosure; and

FIG. 8 is a structural block diagram of an electrical device according to some embodiments of the present disclosure.

### DETAILED DESCRIPTION

For ease understanding of the solutions of the present disclosure by those of ordinary skill in the art, the embodiments of the present disclosure will be described in conjunction with the accompanying drawings in the embodiments of the present disclosure. The described embodiments are merely some embodiments, rather than all embodiments, of the present disclosure. Based on the embodiments in the present disclosure, all other embodiments derived by a person of ordinary skill in the art without creative efforts shall fall within protection scope of the present disclosure.

It should be noted that the terms “first,” “second” and the like in the description and claims, as well as the above-mentioned accompanying drawings, of the present disclosure are used to distinguish similar objects, but not necessarily used to describe a specific order or precedence order. It should be understood that data used in this way may be interchanged where appropriate, such that the embodiments of the present disclosure described herein can be implemented in a sequence other than those illustrated or described herein. Furthermore, the terms “including” and “having” and any variants thereof are intended to cover non-exclusive inclusions. For example, a process, method, system, product, or device that includes a series of processes or units is not necessarily limited to those processes or units that are clearly listed, but may include other processes or units that are not clearly listed or are inherent to such processes, methods, products, or devices.

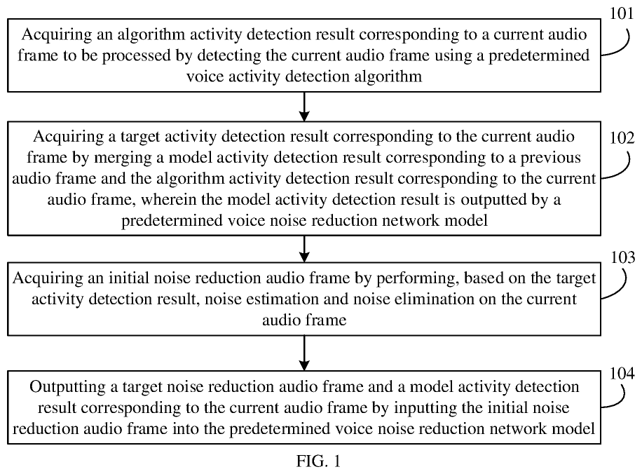

FIG. 1 is a schematic flowchart of a method for reducing voice noise according to some embodiments of the present disclosure. These embodiments are applicable to the situation of noise reduction to voices, e.g., these embodiments are applicable to various scenarios such as voice calls, audio and video live broadcasts and multi-person conferences. This method may be performed by an apparatus for reducing voice noise, which may be implemented in the form of hardware and/or software. The apparatus for reducing voice noise may be configured in an electrical device such as a voice noise reduction device. The electrical device may be a mobile device such as a mobile phone, a smart watch, a tablet computer or a personal digital assistant; or may be other devices such as a desktop computer. As illustrated in FIG. 1, the method includes the following processes 101-104.

In process 101, an algorithm activity detection result corresponding to a current audio frame to be processed is acquired by detecting the current audio frame using a predetermined voice activity detection algorithm.

In some embodiments, the current audio frame to be processed is understood as a current audio frame that needs to be performed with voice noise reduction, and the current audio frame may be contained in an audio file or audio stream. In some embodiments, the current audio frame is an original audio frame in the audio file or audio stream, or an audio frame acquired by preprocessing the original audio frame.

In these embodiments of the present disclosure, the voice noise reduction solution as a whole may be understood as a voice noise reduction system, and the current audio frame may be understood as an input signal of the voice noise reduction system. The voice noise reduction solution may contain a traditional voice noise reduction algorithm and an AI voice noise reduction model.

For example, the type of the traditional voice noise reduction algorithm may be an adaptive noise suppression (ANS) algorithm in web real-time communication (webRTC), a linear filtering method, a spectral subtraction method, a statistical model algorithm, or a subspace algorithm. The traditional voice noise reduction algorithm mainly includes voice activity detection (VAD) estimation, noise estimation and noise elimination. Voice activity detection, also known as voice endpoint detection or voice boundary detection, may identify a long silence period from sound signal streams. The predetermined voice activity detection algorithm in these embodiments of the present disclosure is a voice activity detection algorithm in any traditional voice noise reduction algorithm.

The predetermined voice noise reduction network model in the present disclosure may be an AI voice noise reduction model, which may include a RNNoise model or a dual-signal transformation LSTM network for real-time noise suppression (DTLN) noise reduction model, or the like. The predetermined voice noise reduction network model includes two branches, wherein one branch is used to output a noise reduction voice (also referred to as a noise reduction branch) and the other branch is used to output a voice activity detection result (also referred to as a detection branch). For the AI voice noise reduction model that already includes the detection branch, an original model structure can be maintained. For the AI voice noise reduction model that do not include the detection branch, the detection branch can be added to a backbone network, and a network structure of the detection branch may, for example, include a convolutional layer and/or a fully connected layer, etc.

RNNoise is a noise reduction solution that combines audio feature extraction+deep neural network.

In some embodiments, in order to distinguish voice activity detection results from different sources, after the predetermined voice activity detection algorithm is used to detect the current audio frame to be processed, a detection result is denoted as an algorithm activity detection result, and an activity detection result outputted by the predetermined voice noise reduction network model is denoted as a model activity detection result.

In process 102, a target activity detection result corresponding to the current audio frame is acquired by merging a model activity detection result corresponding to a previous audio frame and the algorithm activity detection result corresponding to the current audio frame, wherein the model activity detection result is outputted by a predetermined voice noise reduction network model.

In some embodiments, the previous audio frame is understood as the most recent audio frame before the current audio frame. That is, the previous audio frame is before the current audio frame, and the two frames have sequence numbers adjacent to each other. In the case that the previous audio frame is subjected to voice noise reduction processing, the predetermined voice noise reduction network model may output a noise reduction audio frame corresponding to the previous audio frame and the model activity detection result, and the model activity detection result is cached for noise reduction processing of the current audio frame.

In these embodiments of the present disclosure, in the case that the current audio frame is processed, the model activity detection result corresponding to the previous audio frame and the algorithm activity detection result corresponding to the current audio frame can be combined to determine the activity detection results (target activity detection results) used for noise estimation and noise elimination in the traditional voice noise reduction algorithm. Compared with the traditional voice noise reduction algorithm for voice activity detection alone, the traditional noise reduction algorithm can acquire more VAD information, so as to acquire more accurate noise estimation, better protect the voices and eliminate the noises more accurately, thereby increasing an output signal to noise ratio (SNR) of the traditional noise reduction algorithm.

In process 103, an initial noise reduction audio frame is acquired by performing, based on the target activity detection result, noise estimation and noise elimination.

In some embodiments, after the target activity detection result is acquired, a noise estimation algorithm and a noise elimination algorithm in the traditional voice noise reduction algorithms are used to process the current audio frame accordingly, and the processed audio frame is denoted as the initial noise reduction audio frame.

In process 104, a target noise reduction audio frame and a model activity detection result corresponding to the current audio frame are output by inputting the initial noise reduction audio frame into the predetermined voice noise reduction network model.

In some embodiments, after the initial noise reduction audio frame is acquired, the initial noise reduction audio frame is directly used as an input of the predetermined voice noise reduction network model; or the initial noise reduction audio frame is converted based on the characteristics of the predetermined voice noise reduction network model, such as converting into a signal with a predetermined dimension, wherein the predetermined dimension may be a frequency domain, a time domain or another dimension domain.

According to the method for reducing voice noise provided by the embodiments of the present disclosure, the algorithm activity detection result corresponding to the current audio frame to be processed is acquired by detecting the current audio frame using the predetermined voice activity detection algorithm; the target activity detection result corresponding to the current audio frame is acquired by merging the model activity detection result corresponding to the previous audio frame and the algorithm activity detection result corresponding to the current audio frame, wherein the model activity detection result is outputted by the predetermined voice noise reduction network model; the initial noise reduction audio frame is acquired by performing, based on the target activity detection result, noise estimation and noise elimination on the current audio frame; and the target noise reduction audio frame and the model activity detection result corresponding to the current audio frame are output by inputting the initial noise reduction audio frame into the predetermined voice noise reduction network model. By adopting the above solution, the predetermined voice noise reduction network model can output the model activity detection result, and in the case that the current audio frame is processed by the traditional voice noise reduction algorithm, the model activity detection result of the previous audio frame can be merged with the algorithm activity detection result acquired by the traditional voice noise reduction algorithm, such that the traditional noise reduction algorithm can acquire more activity detection information and determine the voice activity detection result more reasonably and accurately. Based on this result, noise estimation and noise elimination can be performed to protect voices and eliminate more noises well, thereby acquiring the traditional noise reduction results with higher signal to noise ratio. Then, the traditional noise reduction results are used as an input of the predetermined voice noise reduction network model, and the noise reduction audio frame with better effect is acquired, thereby reducing the possibility of bad data processed by the predetermined voice noise reduction network model. The traditional noise reduction algorithm and the AI noise reduction method promote each other, and have good noise reduction capability for various noises, thereby improving the stability and robustness of the overall voice noise reduction solution.

In these embodiments of the present disclosure, the voice activity detection may be at a frame level or at a frequency point level, and the detection result may be represented by one or more probability values.

In some embodiments, the algorithm activity detection result includes a first probability value of a voice present in a corresponding audio frame, and the model activity detection result includes a second probability value of a voice present in the corresponding audio frame. The acquiring the target activity detection result corresponding to the current audio frame by merging the model activity detection result corresponding to the previous audio frame with the algorithm activity detection result corresponding to the current audio frame includes: acquiring a third probability value by calculating the first probability value in the model activity detection result corresponding to the previous audio frame and the second probability value in the algorithm activity detection result corresponding to the current audio frame in a predetermined calculation mode, and determining the target activity detection result corresponding to the current audio frame based on the third probability value. With this setting, the target activity detection result is accurately determined for frame-level voice activity detection.

The first probability value represents a probability that the corresponding audio frame contains a voice after the corresponding audio frame is detected using the predetermined voice activity detection algorithm. The corresponding audio frame here may be any audio frame, or the current audio frame, or the previous audio frame, and the first probability values corresponding to different audio frames may be different. The second probability value represents a probability that the corresponding audio frame outputted by the predetermined voice noise reduction network model contains a voice, and the corresponding audio frame here may be any audio frame, and the second probability values corresponding to different audio frames may be different.

In some embodiments, the first probability value in the algorithm activity detection result corresponding to the current audio frame represents a probability that the acquired current audio frame contains a voice after the current audio frame (assumed to be denoted as A) is detected by the predetermined voice activity detection algorithm, which may be denoted as Pa. The second probability value in the model activity detection result corresponding to the previous audio frame represents a probability that the previous audio frame predicted by the predetermined voice noise reduction network model contains a voice when the previous audio frame (assumed to be denoted as B) is subjected to voice noise reduction, which may be denoted as Pb. Pa and Pb are calculated using a predetermined calculation mode to acquire the third probability value, which may be denoted as Pc. In some embodiments, the third probability value is used as the target activity detection result corresponding to the current audio frame.

In some embodiments, the predetermined calculation mode is one of taking a maximum value, taking a minimum value, calculating an average value, summing, calculating a weighted sum, or calculating a weighted average value. By taking the maximum value as an example, Pc=max (Pa, Pb).

In some embodiments, the algorithm activity detection result includes a fourth probability value of a voice present in each of a predetermined number of frequency points in the corresponding audio frame. The model activity detection result includes a fifth probability value of a voice present in each of the predetermined number of frequency points in the corresponding audio frame. The acquiring the target activity detection result corresponding to the current audio frame by merging the model activity detection result corresponding to the previous audio frame with the algorithm activity detection result corresponding to the current audio frame includes: acquiring a sixth probability value, for each of the predetermined number of frequency points, by calculating the fifth probability value of a single frequency point in the model activity detection result corresponding to the previous audio frame and the fourth probability value of the single frequency point in the algorithm activity detection result corresponding to the current audio frame in a predetermined calculation mode; and determining the target activity detection result corresponding to the current audio frame based on the predetermined number of sixth probability values. With this setting, the target activity detection result is determined more accurately for frequency-point-level voice activity detection.

In some embodiments, the predetermined number (denoted as n) is set based on actual needs, e.g., determined based on the number of points used for the fast Fourier transform in a preprocessing phase, e.g., n is 256. The fourth probability value corresponding to the current audio frame represents a probability that each of the predetermined number of frequency points in the acquired current audio frame contains a voice after the current audio frame (assumed to be denoted as A) is detected by the predetermined voice activity detection algorithm, which may be denoted as PA[n]. PA[n] is understood as a vector containing n elements (n bits), each with a value between 0 and 1, and the value of one element represents a probability that the corresponding frequency point contains a voice. The fifth probability value corresponding to the previous audio frame represents a probability that each of the predetermined number of frequency points in the previous audio frame predicted by the predetermined voice noise reduction network model contains a voice when the previous audio frame (assumed to be denoted as B) is subjected to voice noise reduction, which may be denoted as PB[n]. PA[n] and PB[n] are calculated using the predetermined calculation mode to acquire the predetermined number of sixth probability values, which may be denoted as PC[n]. In some embodiments, a vector containing the sixth probability value is used as the target activity detection result corresponding to the current audio frame.

In some embodiments, the predetermined calculation mode is one of taking a maximum value, taking a minimum value, calculating an average value, summing, calculating a weighted sum, or calculating a weighted average value. By taking the maximum value as an example, PC[n]=max(PA[n], PB[n]). For example, for the first frequency point in the current audio frame, the maximum value of the corresponding fourth probability value and fifth probability value is used as the sixth probability value corresponding to the first frequency point in the current audio frame, and so on.

In some embodiments, the inputting the initial noise reduction audio frame into the predetermined voice noise reduction network model includes: acquiring a target input signal by performing feature extraction with a predetermined feature dimension on the initial noise reduction audio frame; and inputting the target input signal into the predetermined voice noise reduction network model, or inputting the target input signal and the initial noise reduction audio frame into the predetermined voice noise reduction network model. With this setting, feature extraction is performed in a targeted mode, thereby improving the prediction accuracy and precision of the predetermined voice noise reduction network model.

In some embodiments, the predetermined feature dimension includes an explicit feature dimension, which may be a fundamental frequency feature, such as pitch, or a per-channel energy normalization (PCEN) feature, or a Mel frequency cepstrum coefficient (MFCC) feature. The predetermined feature dimension may be determined based on a network structure or characteristics of the predetermined voice noise reduction network model.

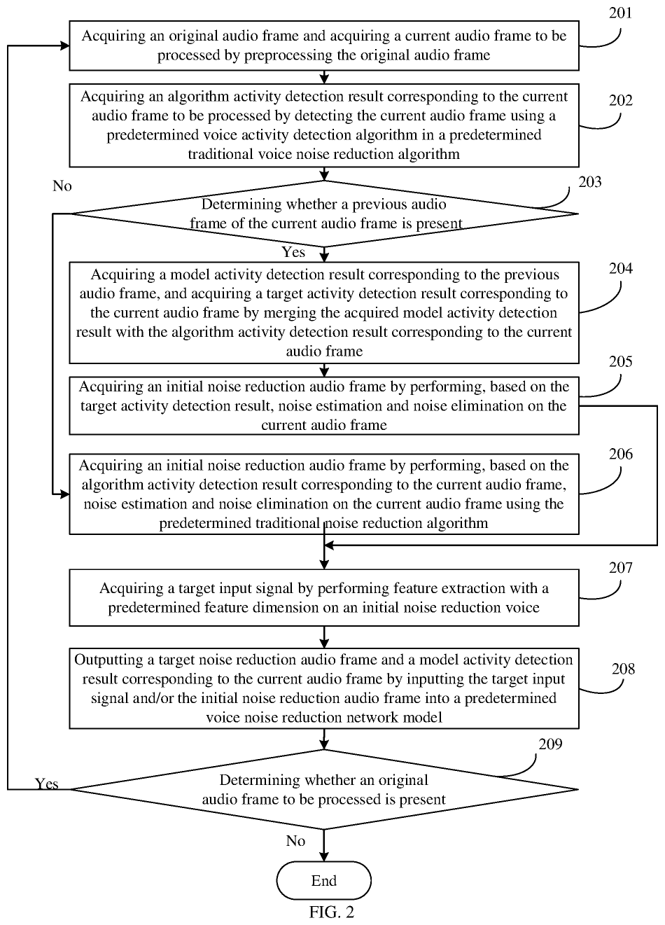

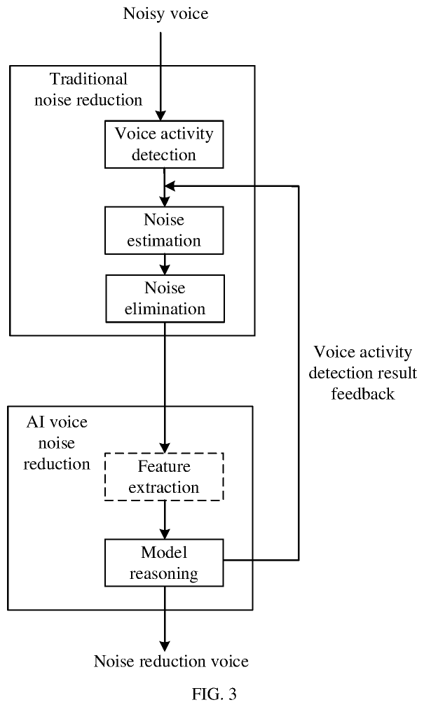

FIG. 2 is a schematic flowchart of another method for reducing voice noise according to some embodiments of the present disclosure. This method may be optimized based on the above optional embodiments. FIG. 3 is a schematic flowchart of reasoning of a method for reducing voice noise according to some embodiments of the present disclosure. The solutions of the embodiments of the present disclosure can be understood in conjunction with FIG. 2 and FIG. 3. As illustrated in FIG. 2, this method may include the following processes 201-209.

In process 201, an original audio frame is acquired and a current audio frame to be processed is acquired by preprocessing the original audio frame.

In some embodiments, the original audio frame is contained in an audio file or audio stream, for example, the original audio frame is an audio stream in a voice call scenario. To ensure the call quality, it is necessary to perform noise reduction on a call audio. The preprocessing may include processing such as framing, windowing, and Fourier transform. The preprocessed noisy voice frame is the current audio frame to be processed, which is used as an input signal (denoted as S0) of the predetermined traditional noise reduction algorithm.

In process 202, an algorithm activity detection result corresponding to the current audio frame to be processed is acquired by detecting the current audio frame using a predetermined voice activity detection algorithm in the predetermined traditional voice noise reduction algorithms.

In some embodiments, the predetermined traditional noise reduction algorithm is an ANS algorithm. S0 is detected using a predetermined voice activity detection algorithm corresponding to a VAD estimation function module in the ANS algorithm. Assuming that the detection is frequency-point-level detection, a voice presence probability Pf[256] of 256 frequency points are acquired, that is, the algorithm activity detection result corresponding to S0 is acquired.

In process 203, whether the previous audio frame of the current audio frame is present is determined, if the previous audio frame of the current audio frame is present, process 204 is performed; otherwise, process 206 is performed.

In some embodiments, for the first audio frame, there is no previous audio frame. Therefore, process 206 is performed without acquiring the model activity detection result of the previous audio frame, and the noise estimation and noise elimination are performed based on the algorithm activity detection result corresponding to the current audio frame.

In process 204, the model activity detection result corresponding to the previous audio frame is acquired, and a target activity detection result corresponding to the current audio frame is acquired by merging the acquired model activity detection result and the algorithm activity detection result corresponding to the current audio frame.

In some embodiments, the model activity detection result corresponding to the previous audio frame is outputted by an AI-based predetermined voice noise reduction network model, which may be a voice presence probability PF[256] of 256 frequency points in the previous audio frame, and a merged VAD estimation result (target activity detection result) may be acquired by taking the maximum value: P[256]=max(Pf[256], PF[256]).

In process 205, an initial noise reduction audio frame is acquired by performing, based on the target activity detection result, noise estimation and noise elimination on the current audio frame using the predetermined traditional noise reduction algorithm; and then process 207 is performed.

In some embodiments, a voice signal S1 after traditional noise reduction is acquired by achieving the noise estimation and noise elimination by the predetermined traditional noise reduction algorithm based on P[256], that is, the initial noise reduction audio frame is acquired.

In process 206, an initial noise reduction audio frame is acquired by performing, based on the algorithm activity detection result corresponding to the current audio frame, noise estimation and noise elimination on the current audio frame using the predetermined traditional noise reduction algorithm.

In some embodiments, a voice signal S1 after traditional noise reduction is acquired by achieving the noise estimation and noise elimination by the predetermined traditional noise reduction algorithm based on Pf[256], that is, the initial noise reduction audio frame is acquired.

In process 207, a target input signal is acquired by performing feature extraction with a predetermined feature dimension on an initial noise reduction voice.

In some embodiments, S1 is used as the input signal of the predetermined voice noise reduction network model, which may be a signal in a frequency domain, a time domain, or other dimensional domains. Based on different model designs of the predetermined voice noise reduction network model, there may be one-process explicit feature extraction calculation, such as a fundamental frequency feature, and the extracted feature information is denoted as a target input signal S2.

In process 208, a target noise reduction audio frame and a model activity detection result corresponding to the current audio frame are outputted by inputting the target input signal and/or the initial noise reduction audio frame into the predetermined voice noise reduction network model.

In some embodiments, S1 or S2, or both S1 and S2 are used as model input(s) and inputted into the predetermined voice noise reduction network model for reasoning calculation to acquire an output signal. The output signal consists of two parts. The first part is an output S3 of a final noise reduction voice of the method for reducing voice noise. The second part is a VAD output PF[256] of the model, which is used by the traditional voice noise reduction algorithm for processing the next audio frame.

In process 209, whether an original audio frame to be processed is present is determined, and if the original audio frame to be processed is present, process 201 is performed; otherwise, the process ends.

In some embodiments, in the case that a voice call ends and all the original audio frames have been subjected to noise reduction processing, the process ends; and in the case that there are still original audio frames which are not subjected to noise reduction, process 201 is performed to continue the noise reduction processing.

According to the method for reducing voice noise provided by these embodiments of the present disclosure, the traditional noise reduction algorithm can acquire more VAD information by means of information feedback from the AI-based predetermined voice noise reduction network model to the traditional noise reduction algorithm. The VAD estimation of traditional noise reduction and AI noise reduction both uses a frequency point level, which can acquire more accurate noise estimation, such that the traditional noise reduction algorithm can better protect the voices, and eliminate more noises, thereby increasing an output signal to noise ratio of traditional noise reduction. After an initial noise reduction voice signal with high signal to noise ratio is extracted, the input of the predetermined voice noise reduction network model can be enriched, such that the voice noise reduction effect of the model can be promoted while the possibility of the predetermined voice noise reduction network model to process bad data is reduced, thereby promoting the voice noise reduction performance.

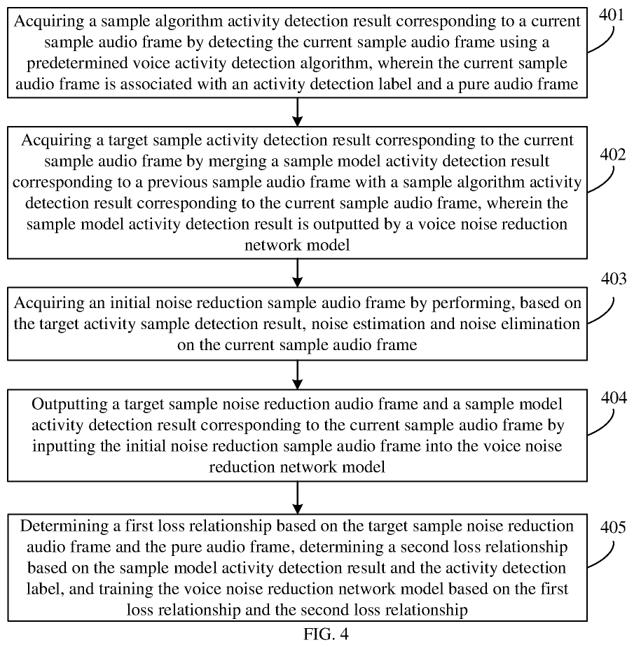

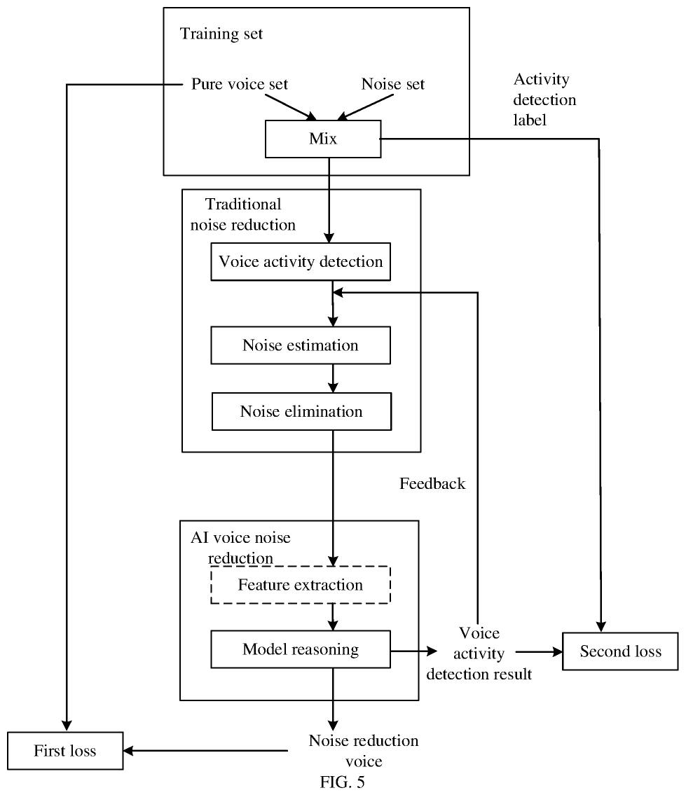

FIG. 4 is a schematic flowchart of a method for training a model according to some embodiments of the present disclosure; and FIG. 5 is a schematic diagram of a training process of a method for training a model according to some embodiments of the present disclosure. The embodiments of the present disclosure may be understood in conjunction with FIG. 4 and FIG. 4. These embodiments may be applied to the training of the AI-based voice noise reduction network model, which may be applied to various scenarios such as voice calls, audio and video live broadcasts, and multi-person conferences. This method may be performed by the apparatus for training a model, which may be implemented in the form of hardware and/or software. This apparatus may be configured in an electrical device such as the model training device. The electrical device may be a mobile device such as a mobile phone, a smart watch, a tablet computer and a personal digital assistant; or may be used for other devices such as a desktop computer. The voice noise reduction network model trained by these embodiments of the present disclosure may be applied to the method for reducing voice noise according to any embodiment of the present disclosure.

As illustrated in FIG. 4, the method includes the following processes 401-405.

In process 401, a sample algorithm activity detection result corresponding to a current sample audio frame is acquired by detecting the current sample audio frame using a predetermined voice activity detection algorithm, wherein the current sample audio frame is associated with an activity detection label and a pure audio frame.

In some embodiments, a pure (clean) voice dataset and a noise dataset are mixed into noisy voice data according to a predetermined mixing rule. The predetermined mixing rule may, for example, be set based on the signal to noise ratio or room impulse response (RIR). In some embodiments, the mixed noisy voice dataset and the pure voice dataset are used together as a training set of the model. The current sample audio frame may be an audio frame in the training set. The current sample audio frame may carry an activity detection label, which may be added by manual annotation. By taking the frame level as an example, in the case that the current sample audio frame contains a voice, the label may be 1, and in the case that the current sample audio frame does not contain a voice, the label may be 0. By taking the frequency point level as an example, the label may be a vector containing a predetermined number of elements, each with a value of 1 or 0; the value is 1 when the corresponding frequency point contains a voice; and the value is 0 when the corresponding frequency point does not contain a voice.

In process 402, a target sample activity detection result corresponding to the current sample audio frame is acquired by merging a sample model activity detection result corresponding to a previous sample audio frame with a sample algorithm activity detection result corresponding to the current sample audio frame, wherein the sample model activity detection result is outputted by a voice noise reduction network model.

In some embodiments, the merging process of the activity detection result in this process is similar to the merging process in the method for reducing voice noise according to the embodiments of the present disclosure, e.g., frequency-point-level merging or frame-level merging. A similar predetermined calculation mode may also be used to merge the corresponding frequency values. The specific details may refer to the relevant content herein, and will not be repeated any further.

In process 403, an initial noise reduction sample audio frame is acquired by performing, based on the target activity sample detection result, noise estimation and noise elimination on the current sample audio frame.

In process 404, a target sample noise reduction audio frame and a sample model activity detection result corresponding to the current sample audio frame are outputted by inputting the initial noise reduction sample audio frame into the voice noise reduction network model.

In process 405, a first loss relationship is determined based on the target sample noise reduction audio frame and the pure audio frame, a second loss relationship is determined based on the sample model activity detection result and the activity detection label, and the voice noise reduction network model is trained based on the first loss relationship and the second loss relationship.

In some embodiments, the loss relationships are used to characterize a difference between the two types of data, which may be represented by loss values, for example, the loss relationship is calculated by using a loss function. The first loss relationship is used to characterize a difference between the target sample noise reduction audio frame and the pure audio frame, and the second loss relationship is used to characterize a difference between the sample model activity detection result and the activity detection label. A first loss function used to calculate the first loss relationship and a second loss function used to calculate the second loss relationship may be set based on actual needs.

In some embodiments, a target loss relationship is calculated based on the first loss relationship and the second loss relationship, and the calculation mode may, for example, be weighted summing, or the like.

In some embodiments, the voice noise reduction network model is trained based on the target loss relationship. In the training process, with the goal of minimizing the target loss relationship, a weight parameter value in the voice noise reduction network model can be continuously optimized using a training method such as backpropagation until a predetermined training cut-off condition is met. The training cutoff condition may be set based on actual needs, e.g., the number of iterations, the degree of convergence of loss values, or the accuracy of the model.

According to the method for training a model provided by these embodiments of the present disclosure, in the training process, the traditional noise reduction algorithm and the voice noise reduction network model are taken as a whole, such that the risk of data mismatch caused by the traditional noise reduction algorithm in series with the separately trained voice noise reduction network model can be avoided. The trained model can be used for voice noise reduction, and has good noise reduction capability for various noises to improve the noise reduction effect.

In some embodiments, the sample algorithm activity detection result includes a first sample probability value of a voice present in a corresponding sample audio frame, and the sample model activity detection result includes a second sample probability value of a voice present in the corresponding sample audio frame.

The acquiring a target sample activity detection result corresponding to the current sample audio frame by merging a sample model activity detection result corresponding to a previous sample audio frame with a sample algorithm activity detection result corresponding to the current sample audio frame includes: acquiring a third sample probability value by calculating the second sample probability value in the sample model activity detection result corresponding to the previous sample audio frame and the first sample probability value in the sample algorithm activity detection result corresponding to the current sample audio frame in a predetermined calculation mode, and determining the target sample activity detection result corresponding to the current sample audio frame based on the third sample probability value.

In some embodiments, the sample algorithm activity detection result includes a fourth sample probability value of a voice present in each of a predetermined number of frequency points in the corresponding audio frame; and the model activity detection result includes a fifth sample probability value of a voice present in each of the predetermined number of frequency points in the corresponding audio frame.

The acquiring a target sample activity detection result corresponding to the current sample audio frame by merging a sample model activity detection result corresponding to a previous sample audio frame with a sample algorithm activity detection result corresponding to the current sample audio frame includes: acquiring a sixth sample probability value, for each frequency point in the predetermined number of frequency points, by calculating the fifth sample probability value of a single frequency point in the sample model activity detection result corresponding to the previous sample audio frame and the fourth sample probability value of the single frequency point in the sample algorithm activity detection result corresponding to the current sample audio frame in a predetermined calculation mode; and determining the target sample activity detection result corresponding to the current sample audio frame based on the predetermined number of sixth sample probability values.

In some embodiments, the inputting the initial noise reduction sample audio frame into the predetermined voice noise reduction network model includes: acquiring a target input signal by performing feature extraction with a predetermined feature dimension on the initial noise reduction sample audio frame; inputting the target input signal into the predetermined voice noise reduction network model, or inputting the target input signal and the initial noise reduction sample audio frame into the voice noise reduction network model.

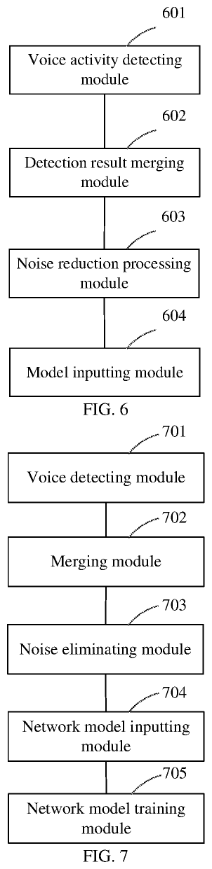

FIG. 6 is a structural block diagram of an apparatus for reducing voice noise according to some embodiments of the present disclosure. This apparatus may be implemented in software and/or hardware, and is generally integrated in an electrical device such as the voice noise reduction device to perform voice noise reduction by executing the method for reducing voice noise. As illustrated in FIG. 6, the apparatus includes: a voice activity detecting module 601, a detection result merging module 602, a noise reduction processing module 603 and a model inputting module 604.

The voice activity detecting module 601 is configured to acquire an algorithm activity detection result corresponding to a current audio frame to be processed by detecting the current audio frame using a predetermined voice activity detection algorithm.

The detection result merging module 602 is configured to acquire a target activity detection result corresponding to the current audio frame by merging a model activity detection result corresponding to a previous audio frame and the algorithm activity detection result corresponding to the current audio frame, wherein the model activity detection result is outputted by a predetermined voice noise reduction network model.

The noise reduction processing module 603 is configured to acquire an initial noise reduction audio frame by performing, based on the target activity detection result, noise estimation and noise elimination on the current audio frame.

The model inputting module 604 is configured to output a target noise reduction audio frame and a model activity detection result corresponding to the current audio frame by inputting the initial noise reduction audio frame into the predetermined voice noise reduction network model.

According to the apparatus for reducing voice noise provided by the embodiments of the present disclosure, the algorithm activity detection result corresponding to the current audio frame to be processed is acquired by detecting the current audio frame using the predetermined voice activity detection algorithm; the target activity detection result corresponding to the current audio frame is acquired by merging the model activity detection result corresponding to the previous audio frame and the algorithm activity detection result corresponding to the current audio frame, wherein the model activity detection result is outputted by the predetermined voice noise reduction network model; the initial noise reduction audio frame is acquired by performing, based on the target activity detection result, noise estimation and noise elimination on the current audio frame; and the target noise reduction audio frame and the model activity detection result corresponding to the current audio frame are output by inputting the initial noise reduction audio frame into the predetermined voice noise reduction network model. By adopting the above solution, the predetermined voice noise reduction network model can output the model activity detection result, and in the case that the current audio frame is processed by the traditional voice noise reduction algorithm, the model activity detection result of the previous audio frame can be merged with the algorithm activity detection result acquired by the traditional voice noise reduction algorithm, such that the traditional noise reduction algorithm can acquire more activity detection information and determine the voice activity detection result more reasonably and accurately. Based on this result, noise estimation and noise elimination can be performed to protect voices and eliminate more noises well, thereby acquiring the traditional noise reduction results with higher signal to noise ratio. Then, the traditional noise reduction results are used as an input of the predetermined voice noise reduction network model, and the noise reduction audio frame with better effect is acquired, thereby reducing the possibility of bad data processed by the predetermined voice noise reduction network model. The traditional noise reduction algorithm and the AI noise reduction method promote each other, and have good noise reduction capability for various noises, thereby improving the stability and robustness of the overall voice noise reduction solution.

In some embodiments, the algorithm activity detection result includes a first probability value of a voice present in a corresponding audio frame, and the model activity detection result includes a second probability value of a voice present in the corresponding audio frame.

The detection result merging module 602 is configured to acquire the target activity detection result corresponding to the current audio frame by merging the model activity detection result corresponding to the previous audio frame with the algorithm activity detection result corresponding to the current audio frame by the following manners:
acquiring a third probability value by calculating the second probability value in the model activity detection result corresponding to the previous audio frame and the first probability value in the algorithm activity detection result corresponding to the current audio frame in a predetermined calculation mode, and determining the target activity detection result corresponding to the current audio frame based on the third probability value.

In some embodiments, the algorithm activity detection result includes a fourth probability value of a voice present in each of a predetermined number of frequency points in the corresponding audio frame; and the model activity detection result includes a fifth probability value of a voice present in each of the predetermined number of frequency points in the corresponding audio frame.

The detection result merging module 602 is further configured to acquire the target activity detection result corresponding to the current audio frame by merging the model activity detection result corresponding to the previous audio frame with the algorithm activity detection result corresponding to the current audio frame by the following manners:
acquiring a sixth probability value, for each of the predetermined number of frequency points, by calculating the fifth probability value of a single frequency point in the model activity detection result corresponding to the previous audio frame and the fourth probability value of the single frequency point in the algorithm activity detection result corresponding to the current audio frame in a predetermined calculation mode; and determining the target activity detection result corresponding to the current audio frame based on the predetermined number of sixth probability values.

In some embodiments, the predetermined calculation mode is one of taking a maximum value, taking a minimum value, calculating an average value, summing, calculating a weighted sum, or calculating a weighted average value.

In some embodiments, the model inputting module includes: a feature extracting unit and a signal inputting unit.

The feature extracting unit is configured to acquire a target input signal by performing feature extraction with a predetermined feature dimension on the initial noise reduction audio frame.

The signal input unit is configured to input the target input signal into the predetermined voice noise reduction network model, or input the target input signal and the initial noise reduction audio frame into the predetermined voice noise reduction network model.

FIG. 7 is a structural block diagram of an apparatus for training a model according to some embodiments of the present disclosure. This apparatus may be implemented in software and/or hardware, and is generally integrated in a computer device, such as the model training device. The model is trained by executing the method for training a model. As illustrated in FIG. 7, the apparatus includes: a voice detecting module 701, a merging module 702, a noise eliminating module 703, a network model inputting module 704 and a network model training module 705.

The voice detection module 701 is configured to acquire a sample algorithm activity detection result corresponding to a current sample audio frame by detecting the current sample audio frame using a predetermined voice activity detection algorithm, wherein the current sample audio frame is associated with an activity detection label and a pure audio frame.

The merging module 702 is configured to acquire a target sample activity detection result corresponding to the current sample audio frame by merging a sample model activity detection result corresponding to a previous sample audio frame with a sample algorithm activity detection result corresponding to the current sample audio frame, wherein the sample model activity detection result is outputted by a voice noise reduction network model.

The noise elimination module 703 is configured to acquire an initial noise reduction sample audio frame by performing, based on the target activity sample detection result, noise estimation and noise elimination on the current sample audio frame.

The network model input module 704 is configured to output a target sample noise reduction audio frame and a sample model activity detection result corresponding to the current sample audio frame by inputting the initial noise reduction sample audio frame into the voice noise reduction network model.

The network model training module 705 is configured to determine a first loss relationship based on the target sample noise reduction audio frame and the pure audio frame, determine a second loss relationship based on the sample model activity detection result and the activity detection label, and train the voice noise reduction network model based on the first loss relationship and the second loss relationship.

According to the method for training a model provided by these embodiments of the present disclosure, in the training process, the traditional noise reduction algorithm and the voice noise reduction network model are taken as a whole, such that the risk of data mismatch caused by the traditional noise reduction algorithm in series with the separately trained voice noise reduction network model is avoided. The trained model can be used for voice noise reduction, and has good noise reduction capability for various noises, thereby improving the noise reduction effect.

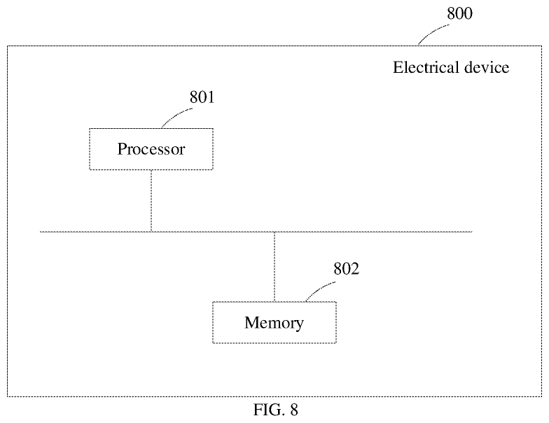

Some embodiments of the present disclosure provide an electrical device. The apparatus for reducing voice noise and/or the apparatus for training a model provided by the embodiments of the present disclosure may be integrated in the electrical device. FIG. 8 is a structural block diagram of an electrical device according to some embodiments of the present disclosure. The electrical device 800 includes a processor 801, and a memory 802 that is in communication connection with the processor 801. The memory 802 is configured to store a computer program that can be executed by the processor 801. The computer program, when executing by the processor 801, causes the processor 801 to perform the method for reducing voice noise and/or the method for training a model provided by any embodiment of the present disclosure. The number of the processors may be at least one. In FIG. 8, one processor is taken as an example.

Some embodiments of the present disclosure further provides a computer-readable storage medium, configured to store a computer program therein, the computer program, when running by a processor, causes the processor to perform the method for reducing voice noise and/or the method for training a model provided by any embodiment of the present disclosure.

Some embodiments of the present disclosure further provides a computer program product, including a computer program, the computer program, when running by a processor, causes the processor to perform the method for reducing voice noise and/or the method for training a model provided by the embodiments of the present disclosure.

The apparatus for reducing voice noise, the apparatus for training a model, the electrical device, the storage medium and the product provided by the above embodiments can perform the method for reducing voice noise or the method for training a model provided by the corresponding embodiments of the present disclosure, and have corresponding functional modules and beneficial effects of performing the method. The technical details which are not described in detail in the foregoing embodiments may refer to the method for reducing voice noise or the method for training a model provided by any embodiment of the present disclosure.

1. A method for reducing voice noise, comprising:
acquiring an algorithm activity detection result corresponding to a current audio frame to be processed by detecting the current audio frame using a predetermined voice activity detection algorithm;
acquiring a target activity detection result corresponding to the current audio frame by merging a model activity detection result corresponding to a previous audio frame and the algorithm activity detection result corresponding to the current audio frame, wherein the model activity detection result is outputted by a predetermined voice noise reduction network model;
acquiring an initial noise reduction audio frame by performing, based on the target activity detection result, noise estimation and noise elimination on the current audio frame; and
outputting a target noise reduction audio frame and a model activity detection result corresponding to the current audio frame by inputting the initial noise reduction audio frame into the predetermined voice noise reduction network model.

2. The method according to claim 1, wherein the algorithm activity detection result comprises a first probability value of a voice present in a corresponding audio frame, and the model activity detection result comprises a second probability value of a voice present in the corresponding audio frame; and
acquiring the target activity detection result corresponding to the current audio frame by merging the model activity detection result corresponding to the previous audio frame with the algorithm activity detection result corresponding to the current audio frame comprises:
acquiring a third probability value by calculating the second probability value in the model activity detection result corresponding to the previous audio frame and the first probability value in the algorithm activity detection result corresponding to the current audio frame in a predetermined calculation mode, and determining the target activity detection result corresponding to the current audio frame based on the third probability value.

3. The method according to claim 1, wherein the algorithm activity detection result comprises a fourth probability value of a voice present in each of a predetermined number of frequency points in a corresponding audio frame; and the model activity detection result comprises a fifth probability value of a voice present in each of the predetermined number of frequency points in the corresponding audio frame; and
acquiring the target activity detection result corresponding to the current audio frame by merging the model activity detection result corresponding to the previous audio frame with the algorithm activity detection result corresponding to the current audio frame comprises:
acquiring a sixth probability value, for each of the predetermined number of frequency points, by calculating the fifth probability value of a single frequency point in the model activity detection result corresponding to the previous audio frame and the fourth probability value of the single frequency point in the algorithm activity detection result corresponding to the current audio frame in a predetermined calculation mode; and
determining the target activity detection result corresponding to the current audio frame based on the predetermined number of sixth probability values.

4. The method according to claim 2, wherein the predetermined calculation mode is one of taking a maximum value, taking a minimum value, calculating an average value, summing, calculating a weighted sum, or calculating a weighted average value.

5. The method according to claim 1, wherein inputting the initial noise reduction audio frame into the predetermined voice noise reduction network model comprises:
acquiring a target input signal by performing feature extraction with a predetermined feature dimension on the initial noise reduction audio frame; and
inputting the target input signal into the predetermined voice noise reduction network model, or inputting the target input signal and the initial noise reduction audio frame into the predetermined voice noise reduction network model.

6. A method for training a model, comprising:
acquiring a sample algorithm activity detection result corresponding to a current sample audio frame by detecting the current sample audio frame using a predetermined voice activity detection algorithm, wherein the current sample audio frame is associated with an activity detection label and a pure audio frame;
acquiring a target sample activity detection result corresponding to the current sample audio frame by merging a sample model activity detection result corresponding to a previous sample audio frame with a sample algorithm activity detection result corresponding to the current sample audio frame, wherein the sample model activity detection result is outputted by a voice noise reduction network model;
acquiring an initial noise reduction sample audio frame by performing, based on the target activity sample detection result, noise estimation and noise elimination on the current sample audio frame;
outputting a target sample noise reduction audio frame and a sample model activity detection result corresponding to the current sample audio frame by inputting the initial noise reduction sample audio frame into the voice noise reduction network model; and
determining a first loss relationship based on the target sample noise reduction audio frame and the pure audio frame, determining a second loss relationship based on the sample model activity detection result and the activity detection label, and training the voice noise reduction network model based on the first loss relationship and the second loss relationship.

7-11. (canceled)

12. The method according to claim 3, wherein the predetermined calculation mode is one of taking a maximum value, taking a minimum value, calculating an average value, summing, calculating a weighted sum, or calculating a weighted average value.

13. The method according to claim 6, wherein the sample algorithm activity detection result includes a first sample probability value of a voice present in a corresponding sample audio frame, and the sample model activity detection result includes a second sample probability value of a voice present in the corresponding sample audio frame;
acquiring the target sample activity detection result corresponding to the current sample audio frame by merging the sample model activity detection result corresponding to the previous sample audio frame with the sample algorithm activity detection result corresponding to the current sample audio frame comprises:
acquiring a third sample probability value by calculating the second sample probability value in the sample model activity detection result corresponding to the previous sample audio frame and the first sample probability value in the sample algorithm activity detection result corresponding to the current sample audio frame in a predetermined calculation mode; and
determining the target sample activity detection result corresponding to the current sample audio frame based on the third sample probability value.

14. The method according to claim 6, wherein the sample algorithm activity detection result includes a fourth sample probability value of a voice present in each of a predetermined number of frequency points in the corresponding audio frame; and the model activity detection result includes a fifth sample probability value of a voice present in each of the predetermined number of frequency points in the corresponding audio frame;
acquiring the target sample activity detection result corresponding to the current sample audio frame by merging the sample model activity detection result corresponding to the previous sample audio frame with the sample algorithm activity detection result corresponding to the current sample audio frame comprises:
acquiring a sixth sample probability value, for each frequency point in the predetermined number of frequency points, by calculating the fifth sample probability value of a single frequency point in the sample model activity detection result corresponding to the previous sample audio frame and the fourth sample probability value of the single frequency point in the sample algorithm activity detection result corresponding to the current sample audio frame in a predetermined calculation mode; and
determining the target sample activity detection result corresponding to the current sample audio frame based on the predetermined number of sixth sample probability values.

15. The method according to claim 6, wherein inputting the initial noise reduction sample audio frame into the predetermined voice noise reduction network model comprises:
acquiring a target input signal by performing feature extraction with a predetermined feature dimension on the initial noise reduction sample audio frame; and
inputting the target input signal into the predetermined voice noise reduction network model, or inputting the target input signal and the initial noise reduction sample audio frame into the voice noise reduction network model.

16. An electrical device for reducing voice noise, comprising:
at least one processor; and
a memory being in communication connection with the at least one processor, wherein
the memory is configured to store a computer program executable by the at least one processor, the computer program, when executed by the at least one processor, causes the at least one processor to perform:
acquiring an algorithm activity detection result corresponding to a current audio frame to be processed by detecting the current audio frame using a predetermined voice activity detection algorithm;
acquiring a target activity detection result corresponding to the current audio frame by merging a model activity detection result corresponding to a previous audio frame and the algorithm activity detection result corresponding to the current audio frame, wherein the model activity detection result is outputted by a predetermined voice noise reduction network model;
acquiring an initial noise reduction audio frame by performing, based on the target activity detection result, noise estimation and noise elimination on the current audio frame; and
outputting a target noise reduction audio frame and a model activity detection result corresponding to the current audio frame by inputting the initial noise reduction audio frame into the predetermined voice noise reduction network model.

17. The device according to claim 16, wherein the algorithm activity detection result comprises a first probability value of a voice present in a corresponding audio frame, and the model activity detection result comprises a second probability value of a voice present in the corresponding audio frame; and
the computer program, when executed by the at least one processor, causes the at least one processor to perform:
acquiring a third probability value by calculating the second probability value in the model activity detection result corresponding to the previous audio frame and the first probability value in the algorithm activity detection result corresponding to the current audio frame in a predetermined calculation mode, and determining the target activity detection result corresponding to the current audio frame based on the third probability value.

18. The device according to claim 16, wherein the algorithm activity detection result comprises a fourth probability value of a voice present in each of a predetermined number of frequency points in a corresponding audio frame; and the model activity detection result comprises a fifth probability value of a voice present in each of the predetermined number of frequency points in the corresponding audio frame; and
the computer program, when executed by the at least one processor, causes the at least one processor to perform:
acquiring a sixth probability value, for each of the predetermined number of frequency points, by calculating the fifth probability value of a single frequency point in the model activity detection result corresponding to the previous audio frame and the fourth probability value of the single frequency point in the algorithm activity detection result corresponding to the current audio frame in a predetermined calculation mode; and
determining the target activity detection result corresponding to the current audio frame based on the predetermined number of sixth probability values.

19. The device according to claim 17, wherein the predetermined calculation mode is one of taking a maximum value, taking a minimum value, calculating an average value, summing, calculating a weighted sum, or calculating a weighted average value.

20. The device according to claim 18, wherein the predetermined calculation mode is one of taking a maximum value, taking a minimum value, calculating an average value, summing, calculating a weighted sum, or calculating a weighted average value.

21. The device according to claim 16, wherein the computer program, when executed by the at least one processor, causes the at least one processor to perform:
acquiring a target input signal by performing feature extraction with a predetermined feature dimension on the initial noise reduction audio frame; and
inputting the target input signal into the predetermined voice noise reduction network model, or inputting the target input signal and the initial noise reduction audio frame into the predetermined voice noise reduction network model.

22. An electrical device for training a model, comprising:
at least one processor; and
a memory being in communication connection with the at least one processor, wherein
the memory is configured to store a computer program executable by the at least one processor, the computer program, when executed by the at least one processor, causes the at least one processor to perform the method for training a model as defined in claim 6.

23. A non-transitory computer-readable storage medium, configured to store a computer program therein, the computer program, when run by a processor, causes the processor to perform the method for reducing voice noise as defined in claim 1.

24. A non-transitory computer-readable storage medium, configured to store a computer program therein, the computer program, when run by a processor, causes the processor to perform the method for training a model as defined in claim 6.
